(19) United States
(12) Patent Application Publication
(10) Pub. No.: US 2026/0159258 A1
(43) Pub. Date: Jun. 11, 2026

(54) AUTONOMOUS FLYING VEHICLE

(71) Applicant: REBLADE APS, Morke (DK)

(72) Inventors: Alexander Andre Westergaard, Ryomgard (DK); Frank Kjerstein, Morke (DK); Steffen Juul Andersen, Vestbjerg (DK)

(73) Assignee: REBLADE APS, Morke (DK)

(21) Appl. No.: 18/705,587

(22) PCT Filed: Oct. 28, 2022
(86) PCT No.: PCT/DK2022/050224

§ 371 Date: Apr. 29, 2024

(30) Foreign Application Priority Data
Oct. 29, 2021 (DK) PA 2021 70532

(51) Int. Cl. B64U 20/70; B64U 10/14; B64U 101/26; F03D 80/55

(52) U.S. Cl. CPC B64U 20/70; B64U 10/14; F03D 80/55; B64U 2101/26; B64U 2201/10

(57) ABSTRACT

The present invention discloses an autonomous flying vehicle having a main tool carrying body. The main tool carrying body includes a front side and a rear side, with body sides connecting the front and rear sides. The tool carrying body includes a plurality of rotors and associated engines and power sources, and further a flight controlling unit including a programmable computer unit., The main tool carrying body also includes attachment means for removably attaching one or more tools to the autonomous flying vehicle. The tool carrying body further has an open longitudinal channel spanning from the front side to the rear side. Furthermore, a method of repairing the surface of a convex composite surface using the inventive autonomous flying vehicle is described.

### CROSS REFERENCE TO RELATED APPLICATION

The present application claims the priority benefits of International Patent Application No. PCT/DK 2022/050224, filed on Oct. 28, 2022, and claims benefit of DK Pat.

Application PA 2021 70532, filed on Oct. 29, 2021, which are hereby incorporated herein by reference in their entireties.

### FIELD OF THE INVENTION

The present invention relates to an autonomous flying vehicle (AFV), and more particularly to a drone having a main tool carrying body.

### BACKGROUND OF THE INVENTION

AFV's are well known and are available in a multitude of designs, sizes and for various purposes. Typically, AFV's are widely used for inspection, and as such are equipped with various video cameras, sensors and probes.

In particular for wind turbine maintenance and especially for detecting damage to wind turbine blades AFV's are seen as a useful tool, see for example US2016/0377424. Usually, wind turbines are positioned in remote areas where access may be difficult, or offshore. Furthermore, wind turbines are positioned at relatively long distances from each other in order not to interfere with the wind patterns and for security reasons. This makes it impossible to position a crane such that more wind turbines may be inspected from the same crane position. This in turn requires reposition of the crane which may be very difficult and time consuming in remote difficult to access areas. As a solution to this problem U.S. Pat. No. 10,776,947 disclose the use of unmanned aerial vehicle which is programmed to register damage to a wind turbine blade during rotation. Based on these results it may be judged whether or not it is necessary to stop the wind turbine and arrange the necessary equipment in order to (manually) repair the wind turbine blade.

In EP3738892 is disclosed an aerial vehicle or a series of aerial vehicles for combining inspection with various cameras, sensors and probes, and carrying out repair, if necessary, of the inspected area. In this disclosure a number of different aerial vehicles are used in order to complete the task. The repair procedure is carried out by an aerial vehicle carrying a repair tool.

One aspect the prior art neglects to address or is best addressed in EP3738892 is the fact that repairing of composite surfaces often requires a number of different tasks. In EP3738892 this is addressed by providing a plurality of aerial vehicles, each vehicle with its own designated specialized task. This of cause implies that a large number of aerial vehicles must be available and on site, as the repairs may have a varying nature and thereby require different treatment etc.

Having realized these and other drawbacks with the prior art the present invention pro-pose a solution where one AFV is able to carry a multitude of different tools and more tools at the same time. Furthermore, by providing a suitable interface between AFV and tools it is accomplished that simple, quick and easy exchange of tools may be carried out.

### SUMMARY OF THE INVENTION

The invention therefore provides an autonomous flying vehicle comprising a main tool carrying body, said main tool carrying body having a front side and a rear side, with body sides connecting said front and rear sides, and where said tool carrying body comprises a plurality of rotors and associated engines and power sources, and further a flight controlling unit including a programmable computer unit, and where further attachment means are provided for attaching tools to the autonomous flying vehicle, where said tool carrying body has an, in use downward open longitudinal channel configured to receive at least part of a surface, such as a convex surface for example in form of a wind turbine blade or at least a part of it such as part of the leading edge of a wind turbine blade, spanning from the front side to the rear side, and where one or more tools may be attached, preferably removably attached to the autonomous flying vehicle.

One of the particular challenges of carrying out repair on the leading edge of the turbine blades is the orientation of the blade. Manual operations include arranging a hoist from the nacelle, such that a carrier may be lifted up and along a vertically arranged blade. By using the prior art AFV's the orientation of the blade has not been used as a parameter for the vehicles nor the method of repair.

With the present invention, the AFV is specifically designed to engage the blade in a position where the blades leading edge is horizontal. The leading edge shall be understood as the turbine blade which cuts through the air, during rotation of the wind turbine blades. Furthermore, the leading edge is a partly round/convex surface of the blade, and as such the leading edge may be understood as that part or area of the wind turbine blade, when projected onto a plane parallel to the longitudinal axis of the blade, is designed to impact the air. The leading edge is therefore not a line, but rather a relatively large area. Due to the travel through the air, any debris in the air will impact the leading edge, and depending on the type of debris (for example hail, dust, snow, etc.) and the impact speed (combination of debris'speed and leading edge velocity) the impact may damage the leading edge/area of the blade. Typically, it is only the leading edge with will deteriorate due to the influence of debris, and as such this is where the bulk of repair works needs to be carried out.

The AFV according to the invention provides a longitudinal channel, which in use is oriented downwards. The channel is designed to accommodate at least a part of the leading edge/area of the wind turbine blade. In some embodiments the AFV will rest on the wind turbine blade, as the blade is inserted into the channel. This provides a very stable and well-defined positioning of the AFV with respect to the blade. Consequently, any repairs may be carried out in a precise manner due to the well-known positioning of the AFV.

In some embodiments the longitudinal channel has a length L, a width W and a depth D, wherein L 40-150 cm, such as 50, 75 or 100 cm or W is 25-75 cm, such as 30, 40, 55 or 60 cm and/or wherein D is 20-60 cm such as 25, 30, 40 or 50 cm. L, D and/or W may be chosen to be larger or smaller depending on the intended use of the AFV.

For example, L=110 cm, D=40 cm, W=40 cm.

In some embodiments L>W and/or L>D and/or W>D and/or W=D, and/or W>D. L, W and/or D may be chosen to ensure an ATV with a channel with dimensions balanced to receive a blade and provide a desired stability and/or area of action for the tool(s).

The dimensions are preferably given as measurements from side to side, top to bottom of the channel itself.

In flight or when not in use, the gripping means and/or tools may be full retracted into the surface/sides of the channel and thereby into the main tool carrying body. In use the gripping means and/or tools may be activated and protrude into the channel in order to make contact with a surface such as the leading edge of a wind turbine blade in the channel.

In some embodiments the AFV has a weight including tool(s) below 75 kg such as or below 70, 60, 50, 40, 30, 25 or 20 kg. Such as between 15 kg-75 kg. Such as 15-25 kg or 25-75 kg,

A prior inspection of the wind turbine blade may have identified the damage, the ex-tend of the damage, the type of damage etc., in such a way, that before launching the AFV towards the blade, it may be equipped with the appropriate tools for carrying out the repair procedure. The tools may quickly be mounted on the AFV grace of the standardized attachment means-common for all the tools contemplated with the AFV.

In this manner the invention provides a versatile tool holder, which in use due to the inventive features provides for a stable and well-defined repair process.

In a further advantageous embodiment, all tools are provided with similar interface connections for connecting and attaching the tool to the main tool carrying body, said interface connections at least comprises means for connecting to at least power, control signals and mechanical fastening.

The provision of similar connections assures as discussed above that exchange of tools may be carried out quickly and without any adaptation processes. Furthermore, as different tools may require different supply a standardized system of attachment means will foresee that tools for example needing electrical power will on the tool side have an appropriate connection means, tools needing pressurized air will have appropriate connection means, tools needing a supply of a grouting mass will have appropriate connection means etc. The AFV may at all attachment points have all types of connection means. In this manner any tool may be connected/attached in any attachment means.

The tools may in a further advantageous embodiment be selected for example between from one or more of the following tools:
a. A chisel
b. A needle hammer (needle scaler or chipping hammer)
c. A grinding/abrasion/milling tool
d. Airgun and/or spraygun
e. Scraper
f. Compound filler/former unit/compound dispensing tool
g. UV or infrared lightsource and/or heating tool
h. Cleaning tool,
i. paint or coating tool

One of the important aspects of the present invention is the AFV's ability to land on the turbine blade. For this purpose, the AFV in a further advantageous embodiment inside the main tool carrying body and as part of the channels surface, is provided with gripping means, such that in use, when the channel is positioned around part of a member to be worked on the gripping means may be expanded in order to fixate or guide the autonomous flying vehicle relative to the member to be worked on.

In this context the term “fixate” shall be understood as when activated the means may maintain the AFV in a desired position in order for the tools to carry out their designated operations. Consequently “fixate” may also be understood as allowing the AFV to move along the member to be worked on, but in such a manner that the AFV is maintained in the correct tilted orientation relative to the blade.

In some embodiments the AFV will physically be in contact with the member to be worked on, also by more of the AFV than the tools actually engaging the surface of the member to be worked on. For example, rollers or the like may be provided such that the AFV may travel on the surface of the member to be worked on. Alternatively, the AFV may hoover above the surface to be worked on, where only the tools are in contact with surface to be worked on.

In some embodiments the main tool carrying body of the AFV comprises an upper body and a lower body, and wherein the longitudinal channel is part of the lower body. A two-part main tool carrying body may provide a flexible system and provide extra options for servicing and/or changing parts of the main tool carrying body.

I.e. in some embodiments the lower body may to be detachable from the upper body. When the lower body is detachable from the upper body, parts of the main tool carrying body of the AFV may be changed, recharged, updated etc. without changing the entire main tool carrying body but by changing the lower body. If for example all or some batteries, oil filters etc. are placed in the lower body these may be changed by changing the lower body.

If the lower body is detachable from the upper body the main tool carrying body may comprise body attachment means for attaching and/or connecting upper and lower body to each other. In some embodiments the body attachment means may allow easy release and attachment of the lower body to the upper body in some embodiments even easy release without the need for tools.

In some embodiments the body attachment means may be configured to ensure that attachment and/or detachment of the lower body can be carried out by remote control of the AFV i.e. without or with reduced physical and/or mechanical interaction by a human on the site of the AFV.

The tool(s) may be attachable to the lower body and/or upper body and/or the tools may be part of the lower body. If the tool(s) are part of the lower body the further attachment means provided for attaching tools to the autonomous flying vehicle may also be the body attachment means. In this case the tools may be changed by changing the lower body.

The present may further relate to a kit for forming an Autonomous flying vehicle as described herein. Said kit may comprise a main tool carrying body and one or more tools. The main tool carrying body of the kit may be a single unit or may comprise an upper and a lower body.

In use the AFV is brought to the site where repair or resurfacing work is to be carried out. In the case of a wind turbine blades front surface, the wind turbines blade is brought into a position where the front surface is facing upwards and substantially horizontal. The AFV is equipped with the tools for the desired treatment of the surface. Typically, a tool selection may be a grinding/sanding tool for preparing the surface. In connection with this tool a blasting or wiping means may be integrated such that the surface is left dust free and cleaned after having been abrasion treated. The prepared surface is thereafter coated by for example a new gel coat layer dispensed by a caulking gun-like device, incorporating a former and finisher spatula, shaping the gel coat material (or other suitable hardenable material) to the desired shape or profile. The AFV is hereby provided with two tools and by the arrangement of the tools in either end of the AFV (or rather the channel provided in the AFV) a working direction is defined, in that the tool/tools preparing the surface are arranged such that the abrasion/cleaning is arranged foremost in the working direction.

After being equipped with tools and repair materials, the AFV is flown to the blade. Here the AFV is positioned at a distance, such as a short distance, from the tip of the blade, oriented with the working direction towards the tip of the blade. Resurfacing is hereafter carried out towards the tip of the blade. Once this part of the blade is treated the AFV is elevated (the AFV takes off from the blade) and rotated 180 degrees such that the working direction is now in the opposite direction. The AFV is positioned such that when the resurfacing procedure is commenced there will be a preferably short overlap between the previously resurfaced part and the new resurfacing procedure to be commenced. The tools are activated and the AFV is brought to travel along the blade, until reaching the end of the area where resurfacing/refurbishment is desired. At the same time the gripping means are adjusted depending on the contour of the blade, such that the AFV is maintained in the correct working orientation.

The present also relates to a method of working the AFV in use as described above.

### BRIEF DESCRIPTION OF THE DRAWINGS

The invention will now be explained with reference to the accompanying drawings.

FIG. 1 illustrates a perspective view of an autonomous flying vehicle (AFV) in an operating position, according to an embodiment of the present invention;

FIG. 2 illustrates a side view of the autonomous flying vehicle of FIG. 1;

FIG. 3 illustrates a front view of the autonomous flying vehicle of FIG. 1;

FIG. 4 illustrates a side view of the autonomous flying vehicle of FIG. 1, according to another embodiment of the present invention, where tools are shown being detached from the AFV;

FIG. 5 illustrates a plurality of different (modular) tools attachable to the AFV;

FIG. 6 Illustrates a front view of the autonomous flying vehicle having an upper and a lower main tool carrying body; and

FIGS. 7a-7d illustrate various steps of a method of using the AFV in a repair process.

### DESCRIPTION OF THE PREFERRED EMBODIMENTS

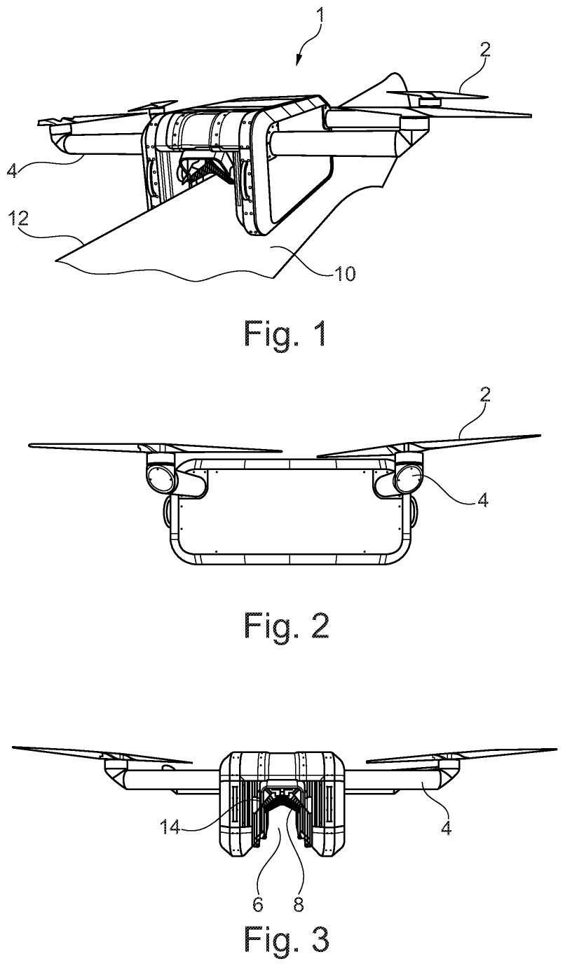

In FIG. 1 is illustrated an autonomous flying vehicle (AFV) according to the invention positioned on an object to be worked on by the AFV.

The AFV (1) in the illustrated embodiment comprises means in the shape of propellers (2) which in turn are connected to suitable motors such that by activating the motors the propellers will be able to elevate the AFV and by suitable control means navigate to any desired position. In this instance, as illustrated in FIG. 1, the AFV has been landed on a wind turbine blade (10). The wind turbine blade (10) is arranged such that the leading edge (12) being a convex surface is in the substantially horizontal plane such that the AFV will be able to settle on the front surface/leading edge (12) in a manner where the channel as will be explained below, will surround part of the leading edge (12). In this position the AFV (1) will be able to travel along the leading edge (12) of the wind turbine blade (10) and carry out any desired preferred procedure.

In FIG. 2 the AFV is illustrated in a side view where it may be seen that the arms (4) with propellers (2) are arranged in either end and extending to either side in order to provide a high degree of stability both during maneuvering of the AFV (1) but also during work on the surface of the object to be worked on.

The AFV is provided with a throughgoing channel 6 as illustrated in FIG. 3, where the AFV is seen from the rear end. The channel 6 is dimensioned such that it may accommodate the object to be worked on, for example a wind turbine blade. The wind turbine blade or at least a part of it, is, as illustrated with reference to FIG. 1, arranged inside the channel 6, such that a well-defined working position of the tools provided on the AFV (1) will be able to carry out their task with a higher degree of precision. Inside the channel (6) are provided gripping means (8) which will be able to be manipulated in order to retain the AFV in a desired position relative to the object to be worked on, for example a wind turbine blade (10). The gripping means (8) may therefore be extended or retracted orthogonal to the longitudinal direction of the channel and in some instances it might be desirable to fixate the AFV with respect to the wind turbine blade and for this purpose the gripping means (8) may fixate the AFV in such a manner that it will be very difficult to move the AFV relative to the wind turbine blade (10). During normal operation of the AFV (1) the gripping means (8) however, will allow the AFV (1) to travel along the leading edge (12) of the wind turbine blade (10) in order to carry out the repair procedure. For this purpose, the gripping means will only stabilize and with as low friction as possible engage the wind turbine blade (10). In other embodiments of the invention, it is foreseen that the entire AFV 1 will hover above the wind turbine blade (10) and as such the gripping means (8) are only meant as guiding means positioning the AFV in its correct position relative to the leading edge (12) of the wind turbine blade (10).

In order to safeguard a substantially enclosed working environment, the channel (6) is in either end provided with a curtain (14).

This curtain (14) assures that the working zone is protected such that rain, wind and the like does not affect the working conditions inside the channel. Furthermore, in some instances it might be necessary to provide heating, and for this purpose curtains (14) in either end of the channel (6) reduces the need for heating in that the heating is maintained in the working zone between the curtains (and cooling from the ambient surroundings is diminished). Heating or infrared light or UV-light, may be used in order to accelerate the hardening of for example a gelcoat or other hard enable material, often two component material applied to the surface. For example, a number of epoxy products are known to be able to harden faster by being exposed to UV-light or infra-red light.

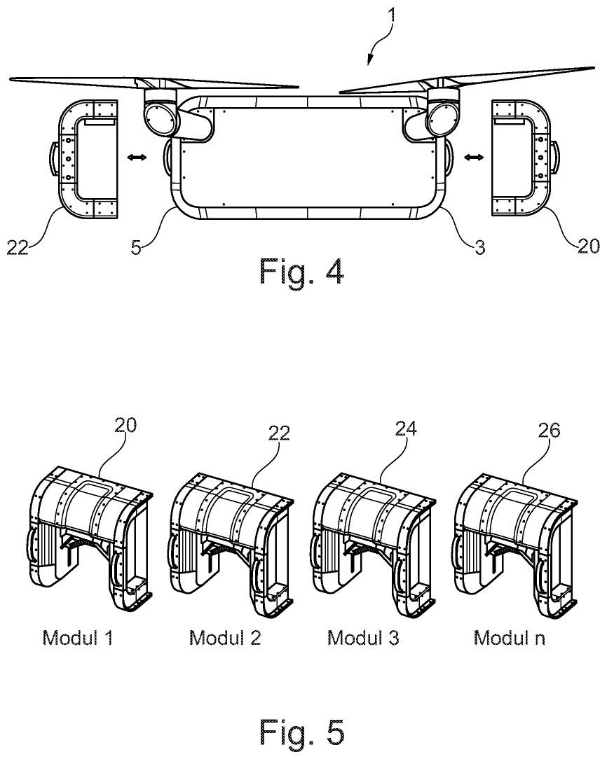

One of the main advantages of the invention is the fact that the tools which will carry out the repair process or the refurbishing may be exchanged according to the circum-stances and according to the desired job. In FIG. 4 is illustrated that two modular tools (20), (22) may be attached to either end of the AFV (1), the tools (20), (22) are provided with, for this AFV, standardized attachment tools and interface means, such that the control unit inside the AFV which is in communication with the control station, for example a hand-held control device, may readily be connected such that its specific tools (20), (22) is connected to the ports and switches which is necessary for that particular tool to carry out its function. This in turn means that some other tools may have a dummy connection provided which are not used but are provided in order to accommodate that the connection means necessarily in order to operate other tools is always foreseen and made room/space for both on the main body of the AFV and on each tool. In this manner the AFV (1) may be configured to carry out a multitude of tasks simply by replacing the tools (20), (22) as desired and as determined in order to carry out the desired refurbishments/repair works.

In FIG. 5 is illustrated a number of different tools (20), (22), (24), (26) which may all be attached to the AFV (1) in the same modular manner. All tools are provided with the same mechanical cross section such that the channel 6 (see FIG. 3) also is provided in the tools (20), (22), (24), (26). Depending on the task which it is determined that the AFV (1) shall carry out, on for example a wind turbine blade (10), an abrasive tool may be selected in order to prepare the surface where the abrasive tools for example as indicated by a number of (20) may be attached to a first end (3) of the AFV whereas a tool (22) for example dispensing a gelcoat or an epoxy resin and shaping this resin to the contour of the blade, may be attached to a second end 5 of the AFV (1).

In this manner a number of repair actions may be carried out by the modular tools. Furthermore, in practice the most common damage to a wind turbine blade is deterioration of the leading edge. By providing an abrasive tool and a tool mixing and dispensing a suitable filler, the refurbishment of a leading edge may be carried out in a single pass of the AFV according to the invention. In practice the present invention employing two modular tools as described above, may from take off on the ground, including positioning on the blade, repair procedure on the distal 10 m of the blade (which are typically the most damaged portion) and return to the ground carry out a repair process in less than 10 minutes. As there is no repositioning of ground equipment the next blade may be treated immediately thereafter. All in all this procedure, because of the versatility of the present invention may carry out a very cost efficient repair procedure.

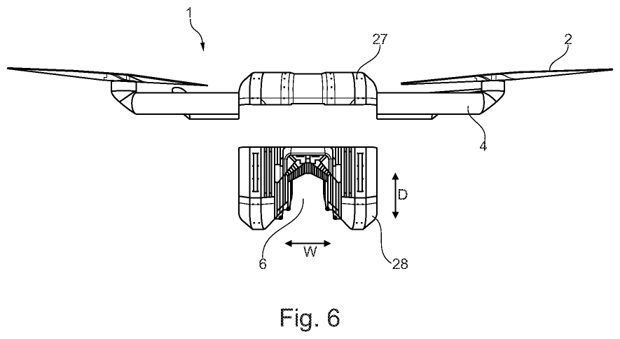

FIG. 6 shows an ATV where the main tool carrying body comprises an upper body 27 and a lower body 28 with a channel 6. In the shown state the lower body 28 is released from the upper body 27. The tool 20 may be attached to the lower body 27 or may be part of the lower body. Width (W) and depth (D) of channel 6 is indicated-Length (L) is perpendicular to W and D and runs from the first end to the second end of the AFV.

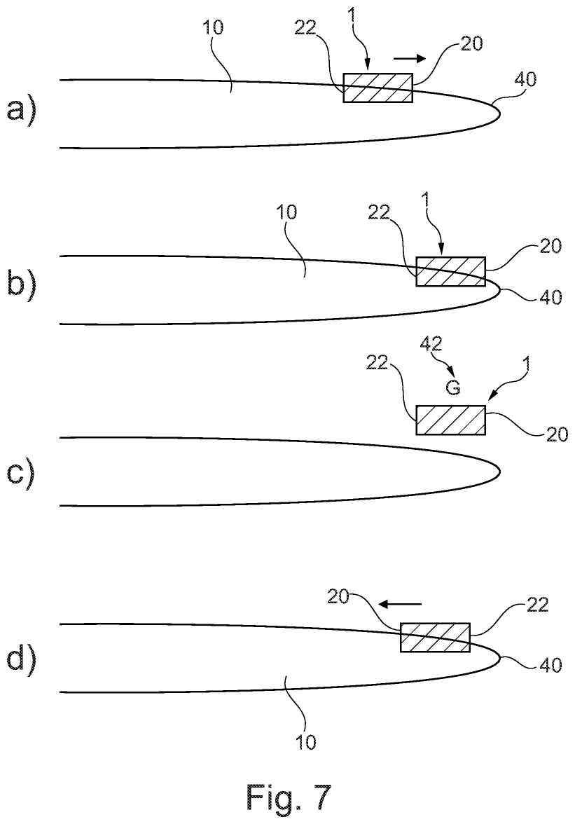

The procedure will be described with reference to FIGS. 7a-7d. The AFV is prepared on the ground meaning that the correct tools are mounted to the main body and the proper repair materials are loaded. Thereafter the AFV is flown to the wind turbine blade (10). Navigation may be carried out partly autonomous, in that a blade navigation system (bns) in the control unit may be activated. As the AFV 1 approaches the blade 10 the bns system takes over and guides the AFV into a proper positioning on the blade. Initially the AFV (1) will land a certain distance in from the tip 40 of the blade 10. When the tools 20,22 are mounted on the AFV (1) they define a direction of work. Initially the tool 20 for carrying out the first process in the repair is facing towards the tip 40.

The AFV will initially work towards the tip 40 as illustrated in FIG. 7a. As the AFV reaches the tip 40 as illustrated in FIG. 7b it will stop. Thereafter the AFV 1 as illustrated in FIG. 7c will take off from the blade 10, and as indicated by the arrow 42 rotate 180 degrees, such that the first tool 20 is now facing away from the tip 40. In this position the AFV will reposition on the blades leading edge again, and, as illustrated in FIG. 7d, commence refurbishing/repair in a direction away from the tip 40. In this manner the entire blades edge may be repaired.

Changes and modifications in the specifically-described embodiments may be carried out without departing from the principles of the present invention, which is intended to be limited only by the scope of the appended claims as interpreted according to the principles of patent law including the doctrine of equivalents.

1. An autonomous flying vehicle (AFV) comprising:
a main tool carrying body, said main tool carrying body having a front side and a rear side, with body sides connecting said front and rear sides, and where said tool carrying body comprises a plurality of rotors and associated engines and power sources, and further a flight controlling unit including a programmable computer unit, and where further attachment means are provided for attaching tools to the autonomous flying vehicle, where said tool carrying body has an, in use downward open longitudinal channel configured to receive at least part of a surface, such as a convex surface, said longitudinal channel spanning from the front side to the rear side, and where one or more tools may be attached to the autonomous flying vehicle.

2. The autonomous flying vehicle according to claim 1, wherein the longitudinal channel has a length L, a width W and a depth D, wherein L 40-150 cm, W is 25-75 cm, and wherein D is 20-60 cm.

3. The autonomous flying vehicle according to claim 2, wherein L>W or W>D, D>W, or D=W.

4. The autonomous flying vehicle according to claim 1, wherein all tools are provided with similar interface connections for connecting and attaching the tool to the main tool carrying body, said interface connections at least comprises means for connecting to at least power, control signals and mechanical fastening.

5. The autonomous flying vehicle according to claim 1, wherein the tools may be selected from one or more of the following tools:
a. A chisel;
b. A needle hammer (needle scaler or chipping hammer);
c. A grinding/abrasion/milling tool;
d. Airgun and/or spray gun;
e. Scraper;
f. Compound filler/former unit/compound dispensing tool;
g. UV or infrared light source and/or heating tool;
h. Cleaning tool;
i. paint or coating tool.

6. The autonomous flying vehicle according to claim 1, wherein inside the main tool carrying body and as part of the channels surface, gripping means are provided, such that in use, when the channel is position around part of a member to be worked on, the gripping means may be expanded in order to fixate or guide the autonomous flying vehicle relative to the member to be worked on.

7. The autonomous flying vehicle according to claim 6, wherein the gripping means has a first flexible plate section forming part of the channel, and where a top flange and bottom flange are arranged at either end of said flexible plate section, where a threaded member is arranged for rotation through threaded apertures in either flange, such that when rotating the threaded member in a first direction the flanges are brought closer together thereby urging the first flexible plate section out of the plane of the channel, and by rotating the threaded member in an opposite second direction, the flanges of the first flexible plate section are forced apart, thereby withdrawing the flexible plate such that the plate will substantially be in plane with the channel.

8. The autonomous flying vehicle according to claim 1, wherein the main tool carrying body comprises an upper body and a lower body, and wherein the longitudinal channel is part of the lower body.

9. The autonomous flying vehicle according to claim 8, wherein the lower body is detachable from the upper body.

10. The autonomous flying vehicle according to claim 8, wherein the tools are attachable to the lower body or upper body or the tools are part of the lower body.

11. A kit for forming an autonomous flying vehicle comprising:
a main tool carrying body and one or more tools, said main tool carrying body having a front side and a rear side, said main tool carrying body comprising a plurality of rotors and associated engines, power sources, and a flight controlling unit including a programmable computer unit, wherein further attachment means are provided for attaching the one or more tools to the autonomous flying vehicle, wherein said tool carrying body has a downward open longitudinal channel configured to receive at least part of a surface, such as a convex surface, said longitudinal channel spanning from the front side to the rear side, and wherein the one or more tools may be attached to the autonomous flying vehicle.

12. A method of using an autonomous flying vehicle (AFV) having a main tool carrying body, a longitudinal channel, a and one or more tools to repair a surface of a convex composite surface, the method comprising:
mounting the AFV using at least two of the one or more tools, wherein a first tool is designated to carry out a first process and a second tool is designated to carry out a second process;
guiding the AFV to land on the convex composite surface, having an apex that is substantially horizontal, such that the apex is inside the longitudinal channel; and
activating the one or more tools of the AFV as the autonomous flying vehicle travels along the convex composite surface to be treated.

13. The method according to claim 12, wherein the convex composite surface to be treated is a front surface of a wind turbine blade, wherein the front surface of the wind turbine blade is arranged horizontally, and wherein the autonomous vehicle is guided to land a predetermined distance from a tip of the blade, wherein the first tool designated for carrying out the first process is facing towards the tip, and wherein the autonomous vehicle first treats the blade towards the tip, after which the AFV is elevated blade or leaves the blade and is rotated 180 degrees such that a new working direction is away from the tip.

14. The method according to claim 13, wherein the AFV is positioned such that when the resurfacing procedure is commenced there will be a short overlap between a previously resurfaced part and a new resurfacing procedure to be commenced.

15. A method according to claim 14, wherein the tools are activated and the AFV is brought to travel along the blade, until reaching the end of the area where resurfacing/refurbishment is desired, preferably at the same time gripping means are adjusted depending on the contour of the blade, such that the AFV is maintained in the working orientation.
